(19) United States
(12) Patent Application Publication
(10) Pub. No.: US 2010/0092933 A1
(43) Pub. Date: Apr. 15, 2010

(54) SYSTEM AND METHOD FOR AN INTERACTIVE PHONEME VIDEO GAME

(76) Inventors: William Kuchera, Ann Arbor, MI (US); Martin Fletcher, Whitmore Lake, MI (US); Alan Aldworth, Ann Arbor, MI (US)

Correspondence Address: SCHOX PLC, 500 3rd Street, Suite 515, San Francisco, CA, 94107, US

(21) Appl. No.: 12/252,293

(22) Filed: Oct. 15, 2008

(51) Int. Cl. G09B 19/04; G10L 15/04

(52) U.S. Cl. 434/185; 704/254

(57) ABSTRACT

The interactive phoneme video game of the present invention includes an action game section where a user can collect a phoneme item. At least one phoneme item is associated with a phoneme from a word. A word and phoneme pairing challenge encourages a user to make use of phoneme information gained during the action game. A phoneme sound is preferably played during interaction with the video game such as when a phoneme item is collected or during navigation of a phoneme keypad.

### TECHNICAL FIELD

This invention relates generally to the children educational game field, and more specifically to a new and useful system and method for an interactive phoneme video game to facilitate phonetic encoding of words by children.

### BACKGROUND

Many attempts have been made to combine the addictive and entertaining properties of video games with reading and phonics education. However, the resultant games often are reduced into simple question and answer game play, tedious repetitive tasks, or other games that not only fail to maintain the attention of a child but fail to take advantage of educational techniques known by cognitive scientists and educators. Thus, there is a need in the children education game field to create a new and useful interactive phoneme video game. This invention provides such a new and useful game.

### BRIEF DESCRIPTION OF THE FIGURES

FIG. 1 is a schematic diagram of the preferred embodiment of the invention.

FIG. 2 is a flowchart diagram of the preferred embodiment of the invention.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. Interactive Phoneme Video Game System

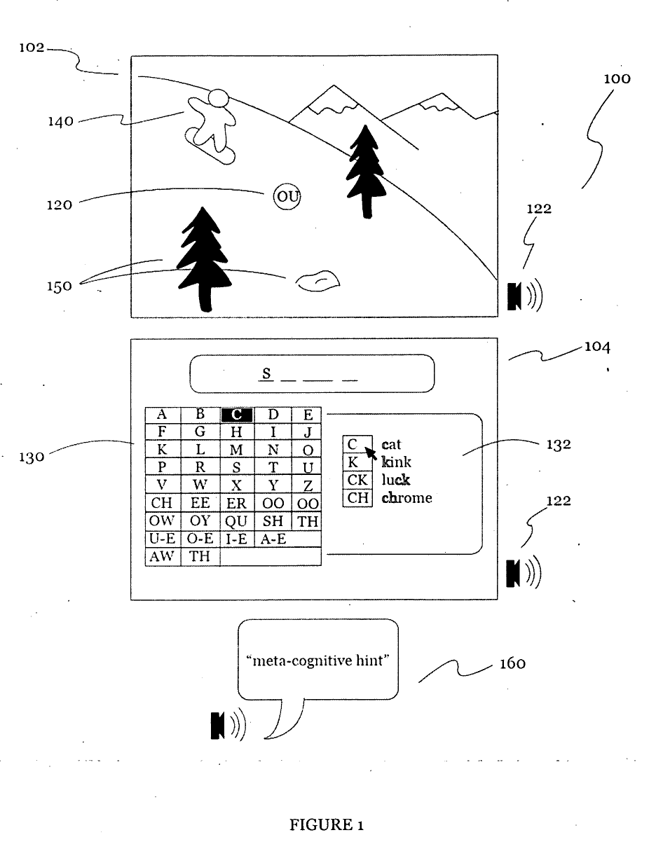

As shown in FIG. 1, the interactive phoneme video game system 100 of the preferred embodiment includes an action game section 102, a word and phoneme pairing challenge 104, a phoneme item 120, and a phoneme sound 122. The interactive phoneme video game system 100 functions to create a fun and entertaining game for children that develops phonemic awareness, phonics, memory, spelling, and word decoding skills. As a user collects a phoneme item 120, the phoneme item 120 and phoneme sound 122 cooperate to develop phonological processing, phonics (sound-to-symbol mapping), and phonemic awareness. The action game section 102 functions to challenge a user with obstacles and various objectives (i.e. avoiding obstacles, completing a mission, playing an opponent), which preferably encourages the user to focus attention and adopt strategies to remember the phoneme item 120 and the phoneme sound 122 and more preferably a sequence of phoneme items 120 and phoneme sounds 122. The word and phoneme pairing challenge 104 preferably functions as a test of the user's retention of the phoneme items 120 and phoneme sounds 122, preferably in the form of a challenge to recall the phonemes of the phoneme items 120 and phoneme sounds 122 in the correct order to form a word. The system is preferably implemented as a computer program, a web application, or any suitable video game medium.

The action game section 102 of the preferred embodiment functions to emulate a traditional arcade-like game. The game preferably follows game patterns as is known in the art such as a side-scroller game, an item collecting game, a role playing game, a puzzle game, an adventure game, a sports game, or any suitable game. During the action game section 102, a user preferably collects a phoneme item 120 or more preferably a sequence of phoneme items. Preferably, the collection of a phoneme item 120 is the main objective of the game. Additionally, the action game section 102 may include a game character 140 that functions to be a user-controlled graphic for collecting phoneme items 120. The game character 140 can preferably be moved on the screen using a mouse, keyboard, joystick, or any suitable input device. The game character 140 preferably collects a phoneme item 120 by navigating to a substantially similar location as the phoneme item 120. As an additional alternative, the video game preferably includes a game obstacle 150. The game obstacle 150 hinders a user from achieving the main objective. The game obstacle 150 preferably injures a game character 140 (e.g., makes the game character “lose a life”), blocks a game character 140 from directly navigating to a phoneme item 120, or acts as any suitable hindrance for the user. Alternatively, the collection of phoneme items 120 may be a side objective to any suitable main objective of the action game section 102.

The word and phoneme pairing challenge 104 of the preferred embodiment functions as the portion of the game when a user uses phoneme information obtained during the phoneme item collection process of the action game section 102. The pairing challenge 104 is preferably arranging phonemes graphically into sequential order to form a word. More preferably, the sequential order is identical to the order that the phoneme items 120 were collected during the action game section 102. The pairing challenge 104 may alternatively be any suitable game such as finding words with phonemes identical to the collected phoneme item or items 120, typing a word using a phoneme, identifying a graphical image of a word with a matching phoneme, or any suitable word and phoneme pairing challenge. Preferably, the pairing challenge 104 is the end of the game or a round of the game, and a user moves on to a new game or round of game if completed successfully. A program preferably verifies the solution provided by a user to determine if the solution is correct or wrong. If the user made an error during the pairing challenge 104, the game 100 is replayed from the beginning. Alternatively, the pairing challenge 104 may be part of a larger game objective. For example, a pairing challenge 104 may occur when a user opens a door, opens a treasure chest, defeats an opponent, or performs any suitable gaming task. The word and phoneme pairing challenge 104 and the action game section 102 preferably occur at different stages of the game to encourage a user to use working memory strategies to retain phoneme information between the two stages of the video game 100, but the challenge game section 104 and the action game section 102 may alternatively occur at the same time or at any suitable times.

As an additional alternative, the word and phoneme pairing challenge 104 includes a separate interface from the action game section 102. The interface is preferably specialized for the word and phoneme pairing challenge. Preferably, the video game 100 includes a phoneme keypad 130 that functions to allow a user to select a phoneme from a substantial menu of phonemes. The phoneme keypad 130 is preferably used for the word and phoneme pairing challenge 104 of selecting phonemes in sequential order to form a word. Alternatively, the video game 100 includes an interface such as a word list, a text entry field, a graphical drag and drop interface, or any suitable interface for any suitable word and phoneme pairing challenge 104.

The phoneme keypad 130 of the preferred embodiment functions to be a user navigable menu of phonemes. The phonemes in the phoneme keypad 130 preferably offers selection of many common phonemes used in a given language (such as English). The phonemes of the collected phoneme items 120 are also preferably included in the phoneme keypad 130. The phonemes in the phoneme keypad 130 may alternatively be phonemes of the collected phoneme items 120, similar sounding phonemes, a random assortment of phonemes, or any suitable collection of phonemes. The phoneme keypad 130 is preferably organized by pronunciation of a phoneme, and a phoneme spelling of a phoneme preferably acts as a visual guide for user navigation. Spelling alternatives of a phoneme are preferably displayed in a submenu 132 after a main phoneme spelling of a phoneme is selected. The alternate spelling submenu 132 is preferably where a user selects a phoneme for a solution to the pairing challenge 104. The spelling alternatives submenu 132 functions to allow mapping between phonetic sound and the correct spelling of a word. Additionally, a phoneme sound 122 is played during navigation of the phoneme keypad 130, and more preferably a phoneme sound 122 is played based on mouse events such as mouse over, mouse click, mouse exit, or any suitable mouse event. For example, a phoneme sound is played each time a mouse moves over a phoneme option in the phoneme keypad 130.

The phoneme item 120 of the preferred embodiment functions as a game item a user collects during the action game section 102. The phoneme item 120 is preferably a graphical icon obtained by a user controlled game character 140, but the phoneme item 120 may alternatively be collected indirectly by performing a game task such as solving a puzzle, defeating an opponent, collecting another item, performing a trick, or any suitable gaming task. The phoneme item 120 is preferably associated with a phoneme from a word, and the textual spelling from the associated word is displayed on the phoneme item or in any suitable position on the screen. The phoneme item 120 additionally has an associated phoneme sound 122. The phoneme sound 122 is preferably played when a phoneme item 120 is collected. The phoneme item 120 is preferably part of a sequence of phoneme items. The sequence of phoneme items can preferably be combined to form a word. Each phoneme item 120 of the sequence of phoneme items is preferably displayed individually and in sequential order according to the spelling/pronunciation of the word. The sequence of phoneme items may alternatively be a random collection of phonemes that combine to form a pseudo word (a word composed of phonemes but not necessarily a real word). There is preferably a time delay between the collection of each phoneme item 120 that functions to allow a user to encode any visual and sound information into working memory. The phoneme items 120 are preferably selected from a database of phonemes, sequence of phonemes, words, or any suitable database.

The phoneme sound 122 of the preferred embodiment functions to reinforce the pronunciation and sound of a word or part of word. The phoneme sound 122 is preferably an audio recording of the pronunciation of a single phonetic part of a word. The phoneme sound is preferably played when a phoneme item 120 is collected. The phone sound is additionally played during navigation of a phoneme keypad or alternatively any suitable interface for the pairing challenge 104. The phoneme sound 122 is preferably individually recorded phonemes, but may alternatively be segmented portions of an audio recording of a word, generated by synthesized voice, or created in any suitable manner.

As an additional alternative to the preferred embodiment, the video game 100 includes a meta-cognitive hint 160 that functions to provide mental strategies to a user during the video game. The meta-cognitive hint 160 is preferably a suggestion for mental strategies for completing the word and phoneme pairing challenge 104 correctly. The meta-cognitive hint 160 preferably provides suggestions for verbal rehearsal, internalized speech, successive processing, and/or any suitable mental strategy. The meta-cognitive hints 160 are preferably audio speech, but may alternatively be communicated using graphics, video, text, or any suitable medium. The meta-cognitive 160 hints are preferably provided after a user failed to complete the pairing challenge successfully, but alternatively, the hints may be supplied before each game, based on a timer, or at any suitable time during the game.

### 2. The Method of an Interactive Phoneme Video Game

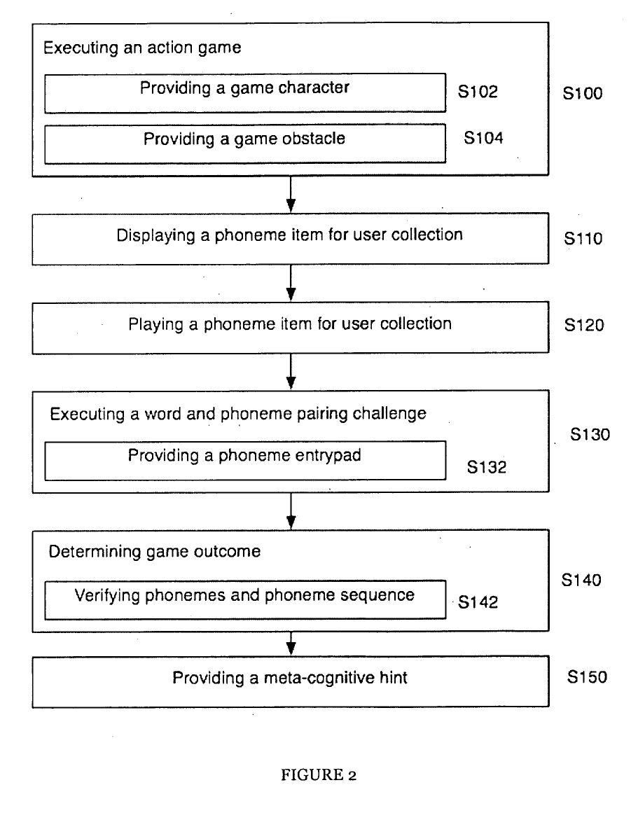

As shown in FIG. 2, the method of an interactive phoneme video game of the preferred embodiment includes executing an action game S100, displaying a phoneme item for user collection Silo, playing a phoneme sound S120, executing a word and phoneme pairing challenge S130, and determining game outcome based on user performance during word and phoneme pairing challenge S140. The method functions to provide an interactive and entertaining game that a user (a child) can play while developing mental skills related to phonemic awareness, phonics, memory, spelling, and word decoding. The method is preferably performed by a computer program, web application, or any suitable gaming medium.

Step 100, which includes executing an action game, functions to operate the action gaming portion of a phonics game. Executing an action game preferably includes handling phoneme items, game characters, game obstacles, any gaming actions such as user input, computer controlled characters, displaying a game background, and/or any suitable aspects of the action game. Executing an action game preferably includes providing a game character that can collect a phoneme item, and additionally includes providing a game obstacle that can hinder collection of a phoneme item. The action game is preferably similar to an arcade game as is known in the art, such as a side-scroller game, an item collecting game, a role-playing game, a puzzle game, an adventure game, a sports game, or any suitable game.

Step 110, which includes displaying a phoneme item for user collection, functions to handle the display, motion, and interactions related to a phoneme item graphic. The phoneme item is preferably an item that is collected by a user through game interactions. A user preferably controls a game character that collects the phoneme item when their graphics are located in substantially similar screen locations. The phoneme item preferably has a phoneme spelling indicated on the graphic of the phoneme item. Alternatively, a phoneme spelling may be indicated elsewhere on the screen or not displayed on the screen. Additionally, a phoneme item may be a sequence of phoneme items that combine to form a word or pseudo word. Preferably, each phoneme item is displayed individually and in sequential order according to the phoneme order in the word. Alternatively, any suitable order or any suitable number of phoneme items may be displayed. Additionally, a time delay is preferably added between the collection of successive phoneme items. The time delay is preferably inherent (caused through normal game mechanics, as in the spacing of phoneme items) or forced (preventing the collection of multiple phoneme items before a time expires).

Step 120, which includes playing a phoneme sound, functions to encourage a user to remember the sound of a phoneme to complete a word and phoneme challenge. Playing a phoneme sound preferably raises phonetic awareness in children. The phoneme sound is preferably played after a phoneme item is collected during the action game section. Additionally, the phoneme sound is preferably played during navigation of a phoneme keypad and more preferably when a phoneme option of the phoneme keypad detects a mouse event such as mouse over, mouse click, mouse exit, or any suitable event.

Step 130, which includes executing a word and phoneme pairing challenge, functions to provide an interface for a user to use phoneme information obtained through collecting phoneme items. The pairing challenge is preferably ordering phonemes in order to form a word, but alternatively the challenge may be finding words with phonemes identical to the collected phoneme item or items, typing a word using the phoneme, identifying a graphical image of a word with a matching phoneme, or any suitable word and phoneme pairing challenge. The step of executing a word and phoneme pairing challenge preferably includes providing a phoneme keypad interface or alternatively providing any suitable interface for a pairing challenge.

The additional step of providing a phoneme keypad adapted to allow a user to select a phoneme from a substantial menu of phonemes functions to allow a user to select a phoneme as part of a solution to the pairing challenge. The phoneme keypad preferably displays a substantial number of phonemes, but alternatively may only offer a limited set of phonemes such as previously collected phonemes, similar phonemes, random phonemes, or any suitable collection of phonemes. The phonemes are preferably organized based on a phonetic sound, and additionally include a phoneme spelling label as a guide to the phoneme sound. The phoneme keypad additionally may display a submenu 132 of alternate spellings of a phoneme. The submenu 132 is preferably displayed when a phoneme is selected. A user can preferably select the correct spelling of a phoneme for a word with the submenu 132. The phoneme keypad preferably allows a user to select a phoneme by clicking, dragging, or through any suitable interaction. A relevant phoneme sound is preferably played when a user navigates a phoneme keypad, and more preferably when a mouse event occurs for a phoneme option such as a mouse over, mouse click, mouse exit or any suitable event.

Step S140, which includes determining game outcome based on user input during word and phoneme pairing challenge, functions to compare a pairing challenge solution provided by a user to a set game solution. The game solution is preferably a word that the collected phoneme items would form if combined. In other variations the solution would be selecting a word or multiple words that contain a phoneme matching the collected phoneme item or items, selecting the correct graphical image, or any solution for a suitable game. A correct solution provided by the user preferably results in the end of the game or alternatively the end of a round of games, a return to the action game section, or any suitable continuation of the game. If a user performance is not successful, the game preferably restarts the game to allow the user to attempt the same game an additional time. Preferably, a user is given a number of chances (e.g., three chances) before a solution is revealed and the game moves on to another stage of a game.

As an alternative addition, the method of the preferred embodiment includes providing a meta-cognitive hint S150. Step S150 functions to encourage the development of mental strategies of a user during the game. The meta-cognitive hints preferably suggest a user to rehearse the phonemes mentally, visualize the collected phonemes as a word, repeat a phoneme out loud, or any suitable hint for user improvement in the game. The meta-cognitive hints are preferably provided via audio speech, but may alternatively be communicated using graphics, video, text, or any suitable medium. The meta-cognitive hints are preferably provided after a user supplies an incorrect solution to a word phoneme pairing task, but alternatively, the hints may be supplied before each game, based on a timer, or at any suitable time during the game.

As a person skilled in the art will recognize from the previous detailed description and from the figures and claims, modifications and changes can be made to the preferred embodiments of the invention without departing from the scope of this invention defined in the following claims.

We claim:

1. An interactive phoneme video game to facilitate phonetic awareness in children comprising:
an action game section where a user can collect a phoneme item;
at least one phoneme item that is associated with a phoneme from a word;
a phoneme sound played during interaction with the video game; and
a word and phoneme pairing challenge.

2. The video game of claim 1 further comprising a meta-cognitive hint adapted to aid a user.

3. The video game of claim 1 wherein the phoneme item is a game graphic and the phoneme spelling of the phoneme is displayed on the screen.

4. The video game of claim 1 wherein the action game section includes a user controlled game character adapted to collect the phoneme item when positioned in a substantially similar location as the phoneme item and a game obstacle that is adapted to hinder the game character from collecting the phoneme item.

5. The video game of claim 1 wherein the phoneme sound is played when a phoneme item is collected.

6. The video game of claim 1 wherein the at least one phoneme item is part of a sequence of phoneme items.

7. The video game of claim 1 wherein the word and phoneme pairing challenge includes a phoneme keypad that is a menu of phonemes.

8. The video game of claim 7 wherein the phoneme keypad facilitates a user selecting phonemes to form a word.

9. The video game of claim 7 wherein the phoneme keypad includes phoneme spelling of a phoneme and a submenu of alternate spellings of a phoneme.

10. A method to facilitate phonetic awareness in children through an interactive phoneme video game comprising the steps:
executing an action game;
displaying a phoneme item for user collection;
playing a phoneme sound;
executing a word and phoneme pairing challenge; and
determining game outcome based on user performance during word and phoneme pairing challenge.

11. The method of claim 10 further comprising the step providing a meta-cognitive hint for the user.

12. The method of claim 10 wherein the step of displaying a phoneme item includes displaying a sequence of phoneme items.

13. The method of claim 12 wherein the step of displaying a sequence of phoneme items includes displaying the phoneme items individually and in sequential order.

14. The method of claim 10 wherein the step executing an action game includes providing a game character that can collects a phoneme item and providing a game obstacle that can hinder the collection of the phoneme item.

15. The method of claim 10 wherein the step of playing a phoneme sound occurs when a phoneme item is collected by the user.

16. The method of claim 10 wherein the step executing a word and phoneme pairing challenge includes facilitating a user selection of a phoneme from a menu of different phonemes.

17. The method of claim 16 wherein the step of playing a phoneme sound occurs when a phoneme item is collected and during the user selection of the phoneme from the menu of different phonemes.

18. The method of claim 16 wherein the step of facilitating a user selection includes facilitating the user selection of a sequence of phonemes that form a word.

19. The method of claim 18 wherein the step of determining game outcome based on user performance includes verifying that the user selected phonemes match the sequence of phonemes items collected during the action game.

20. The method of claim 19 wherein the step of determining game outcome includes verifying that the user selected phonemes are in a correct order to form a word.

21. An interactive phoneme video game to facilitate phonetic awareness in children, comprising:
means for executing an action game that displays a phoneme item, allows a user to collect the phoneme item, and plays a phoneme sound during the collection of the phoneme item;
means for executing a word and phoneme pairing challenge; and
means for determining game outcome based on user performance during word and phoneme pairing challenge.
